(19) United States
(12) Patent Application Publication
(10) Pub. No.: US 2013/0262300 A1
(43) Pub. Date: Oct. 3, 2013

(54) POINT OF SALE SYSTEM WITH TRANSACTION HOLD FUNCTION, AND RELATED PROGRAMS AND METHODS

(71) Applicant: TOSHIBA TEC KABUSHIKI KAISHA, Tokyo (JP)

(72) Inventors: Yumiko OKUMA, Tokyo (JP); Maki Sato, Kanagawa (JP)

(73) Assignee: Toshiba Tec Kabushiki Kaisha, Tokyo (JP)

(21) Appl. No.: 13/768,643

(22) Filed: Feb. 15, 2013

(30) Foreign Application Priority Data
Mar. 30, 2012 (JP) 2012-082704

(51) Int. Cl. G06Q 20/14

(52) U.S. Cl. CPC G06Q 20/14
USPC 705/40

(57) ABSTRACT

A billing system is disclosed. The system is configured to store a plurality of billing data, each billing data related to one of one or more products or services to be sold in a corresponding transaction. The system is further configured to display on a screen a first area that displays a first billing data and a second area that displays a thumbnail of a second billing data, and to process a payment of money with respect to any billing data displayed in the first area. According to a defined user operation, the first billing data displayed in the first area may be treated as being on hold, and a payment of money may be processed with respect to the second billing data.

### CROSS-REFERENCE TO RELATED APPLICATION

This application is based upon and claims the benefit of priority from Japanese Patent Application No. 2012-082704, filed Mar. 30, 2012, the entire contents of which are incorporated herein by reference.

### FIELD

Embodiments described herein relate billing systems and computer programs.

### BACKGROUND

Conventionally, in stores that carry out the sale of various products or offer a variety of services, billing systems such as POS (Point Of Sale) systems and the like are used for billing of the products or services purchased by the customers.

Typical POS systems used in retail stores such as supermarkets and the like are equipped with a scanner device that registers the sales of the given products by scanning the barcode of the products purchased by the customers and the like, and a POS terminal that is connected to this scanner device. The information (hereafter referred to as billing data) related to the one or more products whose sales have been registered at the scanner device is saved sequentially in the memory provided in the POS terminal. The POS terminal then reads out the billing data stored in the memory, and execute the payment processing for the billing data.

The POS terminal typically reads out the billing data in the order in which it is saved in the memory. However, it is expected that there might also be cases wherein it will be necessary to execute the payment processing corresponding to other billing data before that of the current billing data. Taking this into account, in the conventional POS systems, it has became necessary to provide a hold function that puts the current billing data on hold and executes the payment processing corresponding to the other billing data.

Although flexible billing operations for multiple customers may be possible with a hold function, if the same function is used repeatedly, it becomes difficult to associate a customer to the customer's corresponding billing data. As a result, for the customer whose turn it is to pay the money, a mistake such as payment processing being done with the billing data of another customer could occur. Several other problems also exist with the conventional hold function.

Therefore, an improved hold function in the billing system is needed.

### DESCRIPTION OF THE DRAWINGS

FIG. 1 is a diagram of a POS system according to one embodiment.

FIG. 2 is a block diagram showing a configuration of the POS system, according to the embodiment.

FIG. 3 is a flow chart showing a registration processes executed by the POS system, according to the embodiment.

FIG. 4 is a diagram showing a billing Wait Queue provided in the POS system, according to the embodiment.

FIG. 5 is an example of a billing screen, according to the embodiment.

FIG. 6 is a flow chart showing a billing process executed by the POS system, according to the embodiment.

FIG. 7 is a diagram showing a hold function, according to the embodiment.

FIG. 8 is a flow chart showing the hold function provided in the POS system, according to the embodiment.

FIG. 9 is an example of a billing screen after a first defined operation is performed, according to the embodiment.

FIG. 10 is an example of a billing screen after a second defined operation is performed, according to the embodiment.

FIG. 11 is an example of the billing screen after a third defined operation is performed, according to the embodiment.

FIG. 12 is an example of the billing screen after a resume operation is performed, according to the embodiment.

FIG. 13 is a diagram illustrating the POS system according to an embodiment.

### DETAILED DESCRIPTION

According to embodiments, a billing system is disclosed. The billing system comprises a display section comprising at least one screen, an operation section configured to detect a first defined operation and a second defined operation, and a storage section configured to store a plurality of billing data, each billing data related to one of one or more products or services to be sold in a corresponding transaction. The billing system further comprises a display control section configured to display on the screen a first area that displays a first billing data of the plurality of billing data and a second area that displays a thumbnail of a second billing data of the plurality of billing data, a payment control section configured to process a payment of money with respect to any billing data displayed in the first area, and a hold control section. The hold control section is configured to: when the operation section detects the first defined operation on the thumbnail of the second billing data displayed in the second area, instruct the display control section to display on the screen the second billing data in the first area and treat the first billing data that was displayed in the first area before detecting the first defined operation as being on hold, and when operation section detects the second defined operation on the thumbnail of the second billing data after the first defined operation, instruct the payment control section to begin processing a payment of money with respect to the second billing data that is displayed in the first area.

According to additional embodiments, a billing system comprising at least one terminal device and at least one server device is disclosed. The terminal device comprises a display section comprising at least one screen, and an operation section configured to detect a first defined operation and a second defined operation. The server device comprises at least one from among the following: a storage section configured to store a plurality of billing data, each billing data related to one of one or more products or services to be sold in a corresponding transaction, a display control section configured to display on the screen a first area that displays a first billing data of the plurality of billing data and a second area that displays a thumbnail of a second billing data of the plurality of billing data, a payment control section configured to process a payment of money with respect to any billing data displayed in the first area, and a hold control section. The hold control section is configured to: when the operation section detects the first defined operation on the thumbnail of the second billing data displayed in the second area, instruct the display control section to display on the screen the second billing data in the first area and treat the first billing data that was displayed in the first area before detecting the first defined operation as being on hold, and when operation section detects the second defined operation on the thumbnail of the second billing data after the first defined operation, instruct the payment control section to begin processing a payment of money with respect to the second billing data that is displayed in the first area. From among the storage section, the display control section, the payment control section and the hold control section, any items which are not included in the server device, such items are included in the terminal device.

According to additional embodiments, a computer-readable storage medium storing therein a program is disclosed. The program causes a computer system to function as: a display control section configured to display on a screen a first area that displays a first billing data of the plurality of billing data and a second area that displays a thumbnail of a second billing data of the plurality of billing data; a payment control section configured to process a payment of money with respect to any billing data displayed in the first area; and a hold control section. The hold control section is configured to: when the operation section detects the first defined operation on the thumbnail of the second billing data displayed in the second area, instruct the display control section to display on the screen the second billing data in the first area and treat the first billing data that was displayed in the first area before detecting the first defined operation as being on hold, and when operation section detects the second defined operation on the thumbnail of the second billing data after the first defined operation, instruct the payment control section to begin processing a payment of money with respect to the second billing data that is displayed in the first area.

According to the embodiments of the present application, a billing system for use in POS systems provided in retail stores such as supermarkets and the like is disclosed.

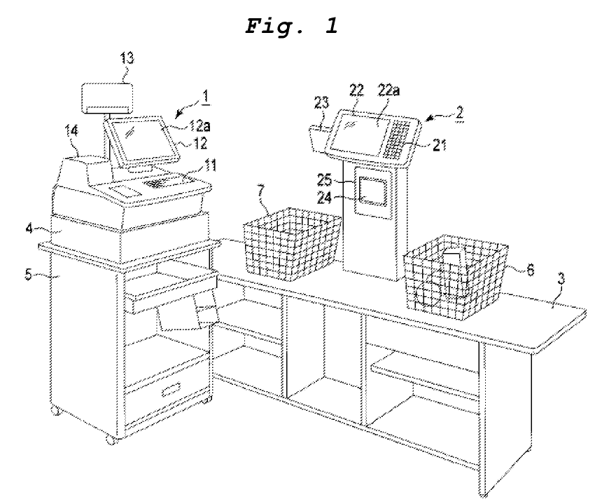

FIG. 1 is a diagram of the POS system according to an embodiment. The system contains a POS terminal 1 and a scanner device 2. The scanner device 2 is arranged on top of the checkout counter 3, which is provided along the checkout lane, i.e., the path of the customers who are checking-out products for a purchasing transaction.

The POS terminal 1 may be located on top of a drawer 4. Drawer 4 maybe located on top of a cash register stand 5 which is provided near one end of the checkout counter 3. The scanner device 2 and POS terminal 1 are connected so as to be able to communicate mutually via a communications cable (not shown in the figure). In FIG. 1, the front side of the checkout counter 3 is the work space for operating the POS terminal 1 and the scanner device 2.

The POS terminal 1 includes: a keyboard 11 equipped with various operation keys, a display 12 for the cashier and a display 13 for the customers. The displays 12 and 13 may be, for example, a liquid crystal display (LCD) device. The POS terminal 1 also includes: a touch panel 12a disposed on the display surface of the display for the cashier 12, and a receipt printer 14 (which may be, for example, a thermal printer). The display 12 for the cashier functions as the display unit according to this embodiment and the touch panel 12a functions as the operation unit according to this embodiment.

The scanner device 2 includes a keyboard 21 equipped with various operation keys, a display 22 for the checker 22 and a display 23 for the customer 23. The displays 22 and 23 may be, for example, liquid crystal display (LCD) devices. The scanner device 2 further includes a touch panel 22a disposed on the display surface 22. The keyboard 21 and the display 22 can have their operating surfaces tilted so as to face the cashier work space. Further, they can be attached to the upper part of the housing 20 that makes up the body of the scanner device 2. The display 23 can be attached to the housing 20 so that its display surface faces the checkout lane.

A scanner 24, which is an input device for inputting a product code, is mounted to the housing 20. The scanner 24 includes a reading window 25 formed in front of the work space of the housing 20. The scanner 24 may be a bar-code scanner that optically scans bar codes attached to products and decodes the product code represented by the bar code. The scanner 24 may also be an imaging system scanner that photographs the bar code using CCD (charge coupled device) imaging elements and recognizes the product code represented by the bar code.

A shopping basket 6, which contains the unregistered products that will be purchased by a shopper, is placed on the surface of the checkout counter 3 upstream from the scanner device 2 (FIG. 1, right side). A shopping basket 7, which contains the products that have been registered by the scanner device 2, is placed on the surface of the checkout counter 3 downstream from the scanner device 2 (FIG. 1, left side).

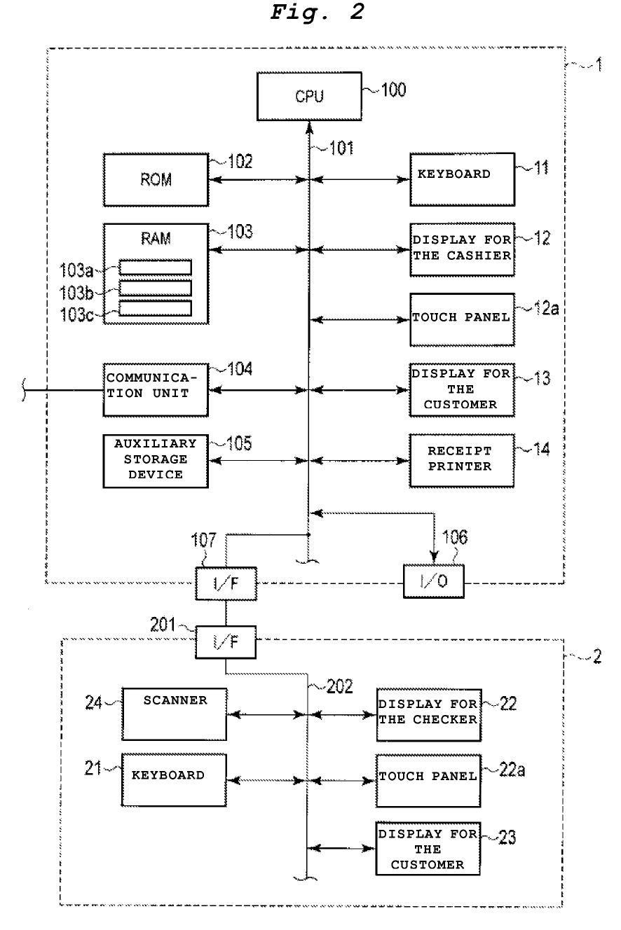

FIG. 2 is a block diagram a configuration of the POS system, according to the embodiment.

The POS terminal 1 includes a CPU (Central Processing Unit) 100 that functions as the controller for the various units. An I/O (input/output) port 106, ROM 102, RAM 103, communications unit 104, auxiliary storage device 105, keyboard 11, cashier display 12, touch panel 12a, customer display 13, receipt printer 14, drawer 4, and I/F (interface) 107 are connected to the CPU 100 via a bus line 101 composed of an address bus and a data bus.

The ROM 102 stores the computer programs to be executed by the CPU 100, or various fixed values and the like. The RAM 103 functions as the main memory of the POS terminal 1.

The RAM 103 includes a product registration buffer 103a, a billing wait queue 103b, and a hold area 103c. When the operating mode of the POS system is set to the business mode (which carries out the registration of products and billing), the product registration buffer 103a temporarily saves product information (such as product name, unit price, purchase quantity and the like,) for the products for which the product codes are input in a single business transaction. The billing wait queue 103b saves one or many of the data which contains the product information of one business transaction hereafter referred to as billing data) saved in the product registration buffer 103a. The hold area 103c saves the billing data which is to be put on hold (such as, for example, future payment processing).

The communications unit 104 carries out mutual communication with store computers via a network such as a LAN (local area network) or the internet.

The auxiliary storage device 105 is, for example, a hard disk drive. The auxiliary storage device 105 stores the operating system files and/or various application files of the POS terminal 1.

The scanner device 2 includes an I/F 201. The scanner 24, keyboard 21, checker display 22, touch panel 22a, and customer display 23 are connected to the I/F 201 via a bus line 202 composed of an address bus and a data bus.

I/F 107 and I/F 201 are connected via a fixed communication cable. Due to this connection, mutual communication between the POS terminal 1 and the scanner device 2 becomes possible. The scanner device 2 operates under the control of the CPU 100.

The registration process of the products using the scanner device 2 will now be described.

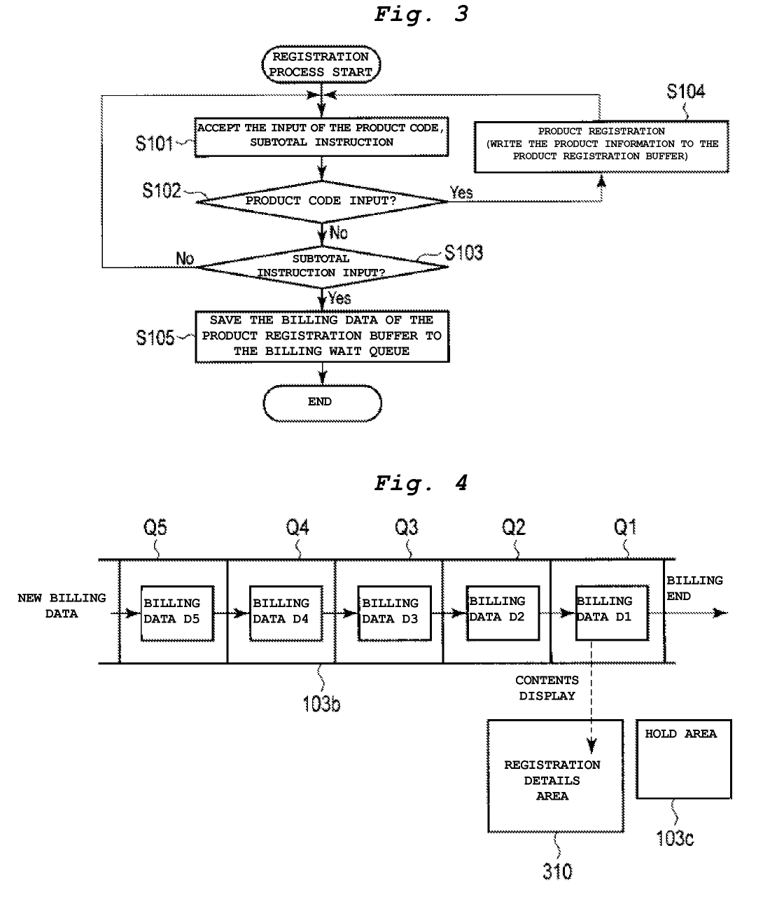

When the operating mode of the POS system is set to the business mode which carries out registration of products and billing, the CPU 100 executes the computer program(s) stored in the ROM 102, RAM 103 or the auxiliary storage device 105, and operates in accordance with the flowchart of FIG. 3.

First, the CPU 100 accepts the input of a product code and a subtotal instruction (Step S101). If a product code is not input (No at Step S102) or the subtotal instruction is not input (No at Step 103), the CPU continues to wait until a product code or the subtotal input is accepted. The product code can be input by scanning the barcode attached to the product by of the scanner 24 or by the operation of preset keys displayed in the display 22. The subtotal instructions can be input by operation of the subtotal key displayed in the display 22. The subtotal key can also be set up on the keyboard 21.

When the checker inputs the product code of the product that the user wants to purchase (Yes of Step S102), the CPU 100 identifies the product name or unit price corresponding to the given product code from the product master, and saves the product information formed by adding other information such as the purchase quantity and the like to this, to the product registration buffer 103a (Step S104). The product master is a file that relates the product name or unit price to the product code, and is stored for example in the auxiliary storage device 105. After Step S104, the operation of the CPU 100 moves to Step S101.

After the completion of the input of the product codes of all the products that a single customer wants to purchase, the checker operates the subtotal key. Due to this operation, the subtotal instruction is input (Yes of Step S103), and the CPU 100 saves the one or multiple products' information, the total of the purchase quantity (total number of items) contained in each product information, the total of the amount of money (total amount) obtained by multiplying the unit price and the purchase quantity contained in each product information and the like saved in the product registration buffer 103a for the given transaction, into the billing wait queue 103b as 1 consolidated billing data (Step S105).

With the above, the registration process that targets one business transaction is complete. The CPU 100 clears the product registration buffer 103a, returns to Step S101, and waits for the input of the product codes and the like for the next business transaction.

FIG. 4 is a diagram showing the billing wait queue 103b. The billing wait queue 103b possesses multiple areas Q for saving the billing data. In FIG. 4, the billing wait queue 103b is shown to have four areas Q1, Q2, Q3, Q4, Q5 and each area Q1 to Q5 stores the billing data D1, D2, D3, D4, D5 in that order. Each area Q is a virtual space that is realized by information processing, and can also be realized by using any address in the RAM 103. Each area can also be suitably added or deleted depending on the total count of the billing data queued.

The billing wait queue 103b is configured as a FIFO (First In First Out) memory. That is, the new billing data that is to be saved in Step S105 is stored at the end of the billing wait queue 103b.

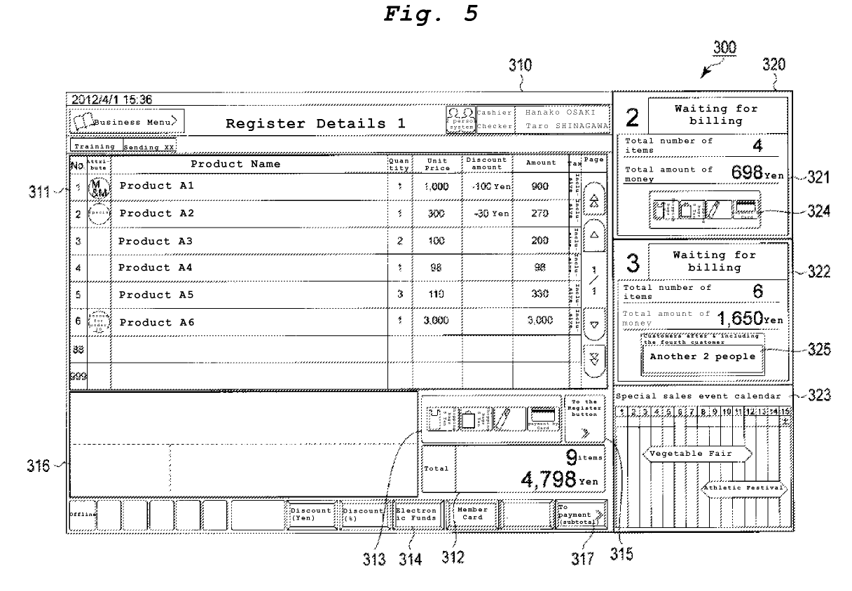

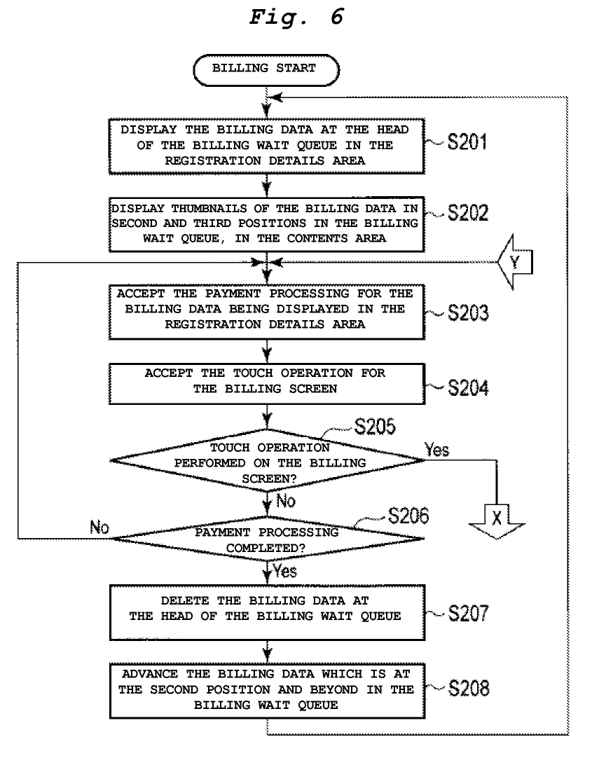

The billing data D1 stored in the area Q1, which is at the head of the billing wait queue 103b, is displayed in the registration details area 310 (refer to FIG. 5) contained in the billing screen displayed in the display for the cashier 12. The billing data D1 is the target of the payment processing of money executed in the POS terminal 1.

An example of the billing screen displayed in the cashier display 12 is shown in FIG. 5. This billing screen 300 contains a registration details area 310 (first area) to display the billing data which will be the target of payment processing, and a contents area 320 (second area) to display the various contents.

The registration details area 310 contains: a product information area 311, totals area 312, Operations buttons group 313, electronic funds button 314, switchover button 315, current area 316 and a subtotals button 317. Furthermore, the contents area 320 contains 3 subareas 321, 322, 323 in which different contents are displayed. The operations buttons group 313, electronic funds button 314, switchover button 315 and the subtotals button 317 can be operated via the touch panel 12a.

The product information area 311 is an area to display the product information contained in the billing data which is the target of the payment processing of money. More specifically, in the product information area 311, the product information contained and displayed in the given billing data (for example as shown in Line 1 of FIG. 5) includes: the product attributes [M & M] (such as a product to be sold as a set or a product that must not be sold to minors and the like), the product name [Product A1] of the registered product, the purchase quantity [1] of registered products, the unit price [1,000] of the registered product, the Discount amount [−100 Yen] of the registered product, the amount [900] obtained by subtracting the discount amount from Unit price×Quantity, and the Classification [Inclusive] of Tax Exclusive/Tax Inclusive.

The totals area 312 is an area for displaying the total number of items and the total amount of money contained in the billing data which is the target of the payment processing of money. For example, in the instance of FIG. 5, in the totals area 312, the total number of items [9 items] and the total amount of money [4,798 Yen] are displayed.

The operations buttons group 313 contains a Shopping bag button for adding the price of the shopping bags to the billing data being displayed in the product information area 311, and a Credit button to declare that the payment of the money will be through a credit card. An electronic funds button 314 is a button to declare that the payment of the money will be through electronic funds.

The switchover button 315 is a button for displaying the Preset keys in order to enter the product codes of the products for which the bar code is not attached. When the Switchover button 315 is operated, multiple preset keys are displayed in place of the product information area 311. These preset keys will be used for the additional registration of products to the billing data being displayed in the product information area 311. If a preset key is operated, the product name and unit price related to the given preset key that is operated is displayed in the Current area 316. If the subtotal button 317 is operated after the additional registration of products, the billing data after the given addition will be fixed as the target of the payment processing.

In subarea 321, the thumbnail of the billing data waiting second in line for the payment processing, i.e. the billing data that is stored in area Q2 of the billing wait queue 103b, is displayed. In subarea 322, the thumbnail of the billing data waiting third in line for the payment processing, i.e. the billing data that is stored in the area Q3 of the billing wait queue 103b, is displayed. The thumbnail of the billing data according to this embodiment contains the total number of items and the total amount of money included in that billing data. However, the thumbnail may also be made up of other information, such as a portion of the product information included in the billing data and the like.

In addition, in subarea 321, an Operations button group 324, which contains operations buttons identical to the operations buttons group 313, is displayed. For example, if the shopping bags button contained in the operations buttons group 324 is operated, the price of the shopping bags gets added to the billing data stored in the area Q2 of the billing wait queue 103b. Another example: if the Credit button is operated, the processing related to payments by credit card will start immediately after the start of the payment processing intended for the given billing data.

In subarea 322 (as indicated by [Another 2 people]), a number of people waiting area 325 is displayed, which shows the count of the billing data stored in the areas Q (Q4, Q5, Q6, . . . ) after the area Q3 of the billing wait queue 103b as the number of customers waiting for billing.

In subarea 323, various contents unrelated to the billing data are shown. FIG. 5 shows an example of a Special Sales event calendar that shows the Special sales days being displayed in the subarea 323. Apart from that, the contents to be displayed in subarea 323 may also be the weather forecast, news, or matters communicated by the headquarters or store managers and the like.

When billing data is stored only in the area Q1 in the billing wait queue 103b, the thumbnails of the billing data, Operations buttons group 324, and Number of people waiting area 325 are not displayed in subareas 321, 322. Also, when billing data is stored only in the areas Q1, Q2 in the billing wait queue 103b and while the thumbnail of the billing data and the operations buttons group 324 is displayed in subarea 321, the thumbnail of the billing data and the Number of people waiting area 325 will not be displayed in the subarea 322. In these cases content such as the weather forecast, news, communication matters and the like may also be displayed in subareas 321, 322.

The operations related to the display of information in each of the areas present in the billing screen 300 described above, or the operations when each of the buttons are operated, are realized by the execution of the computer programs stored in the ROM 102, the RAM 103, or the auxiliary storage device 105 by the CPU 100. In addition, the function where the CPU 100 displays the billing screen 300 in the display for the cashier 12 constitutes the display Control means according to this embodiment.

Next, the billing process which uses a billing screen 300 similar to the one described above is explained in detail.

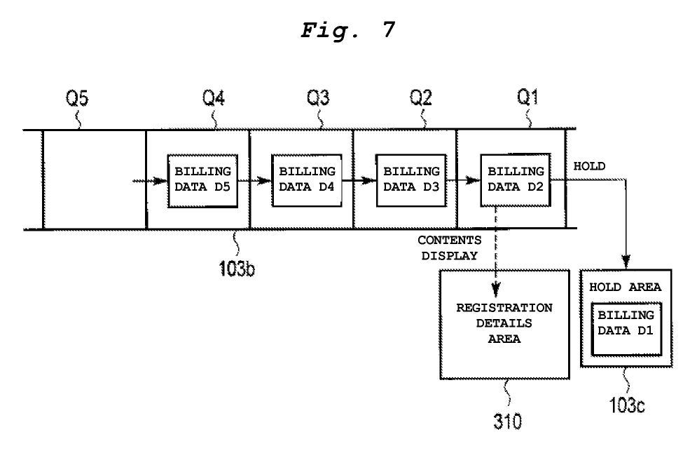

When the operating mode of the POS system is set to the business mode which carries out registration of products and billing, the CPU 100 executes the computer programs stored in the ROM 102, RAM 103 or the auxiliary storage device 105, and operates in accordance with the flowchart of FIG. 6. The process shown in this flowchart is executed in parallel with the registration process described above.

First, the CPU 100 displays the billing screen 300 in the cashier display 12, and at the same time displays the billing data stored in area Q1, which is at the head of the billing wait queue 103b, in the Registration details area 310 (Step S201). That is, the CPU 100 displays all the product information contained in the billing data stored in the area Q1, in the product information area 311 of the Registration details area 310. At the same time, the CPU 100 displays the total number of items and the total amount of money contained in the given billing data in the totals area 312.

Continuing, the CPU 100 displays the thumbnails of the second, third billing data in the billing wait queue 103b, i.e. the billing data stored in the areas Q2, Q3, is displayed in the subareas 321, 322 of the Contents area 320 respectively (Step S202).

In this situation, the CPU 100 accepts payment processing for the billing data being displayed in the registration details area 310 (Step S203), and at the same time, accepts touch operations for the billing screen 300 (Step S204). While executing the processing of Steps S203, S204 the CPU 100 waits for the completion of the touch operations of the billing screen 300 and the payment processing (No of Step S205, No of Step S206).

The payment processing can be implemented using settlement media such as cash, credit card, or electronic funds and the like. In settlements in cash, the cashier operates the keyboard 11 to input the amount of money received from the customer. The cashier then operates the present amount calculation key provided on the keyboard 11. At this time, the CPU 100 calculates the amount of change by subtracting the total amount of money being displayed in the totals area 312 from the given amount of money received, and displays the calculated amount of change at a fixed position of the billing screen 300 and the display for the customer 13. Furthermore the CPU 100 outputs a signal to the drawer 4 via the I/O port 106 to open the drawer 4, and at the same time, issues a receipt of the given transaction to the receipt printer 14. If the customer wishes to settle by means of a credit card, the cashier operates the Credit button of the operations buttons group 313. If the customer wishes to settle by electronic funds, the cashier operates the electronic funds button 314. When the credit button is operated the CPU 100 executes Credit card settlements with well-known procedures. When the electronic funds button 314 is pressed the CPU 100 executes the electronic funds settlements with well-known procedures. Furthermore, the payment processing realized by the CPU 100, constitutes the payment control means according to this embodiment.

If this type of payment processing is completed (Yes of Step S206), the CPU 100 deletes the billing data stored in the area Q1 which is at the head of the billing wait queue 103b (Step S207). Furthermore, the CPU 100 advances and stores the billing data which is in the second and subsequent positions in the billing wait queue, i.e. the billing data stored in the areas Q2, Q3, . . . , to an area one level ahead (Step S208).

After that, the operation of the CPU 100 returns to the step S201. With the billing data which is stored newly in the area Q1 due to the advancement in Step S208 as the target for payment processing, the processing after Step S208 is executed. The above is the basic flow of the payment processing.

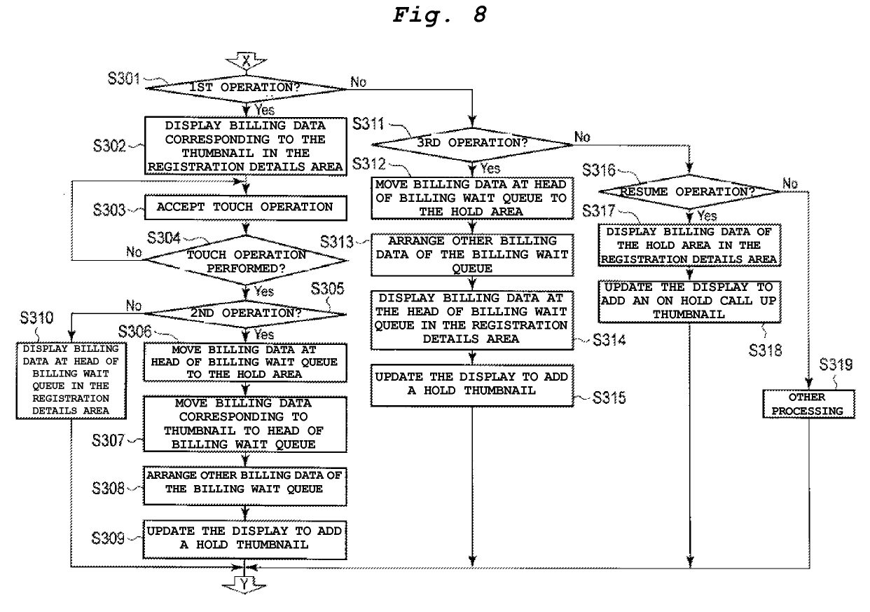

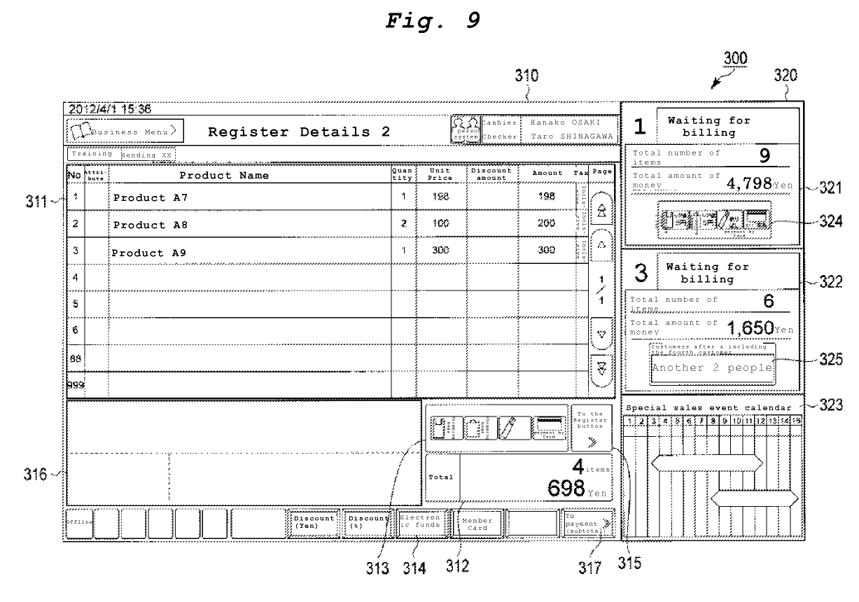

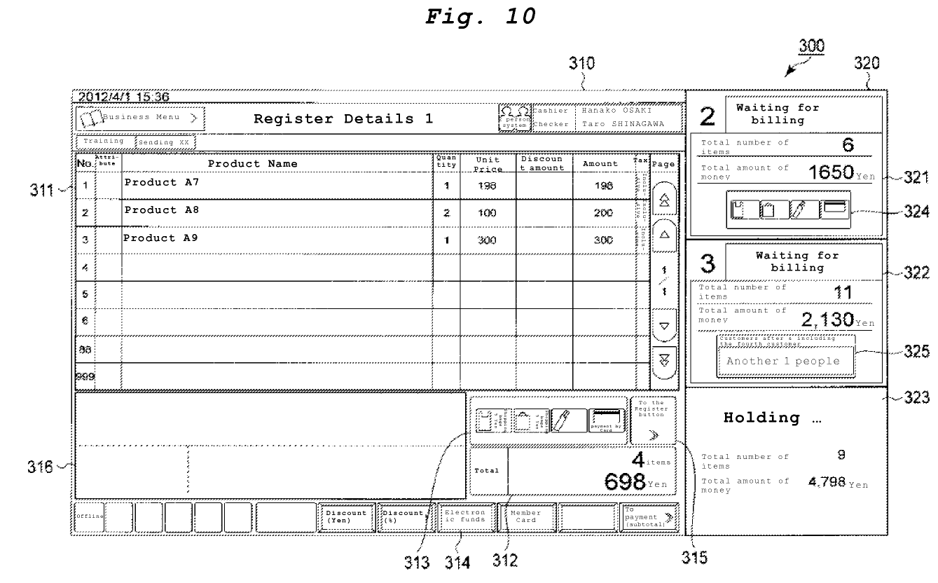

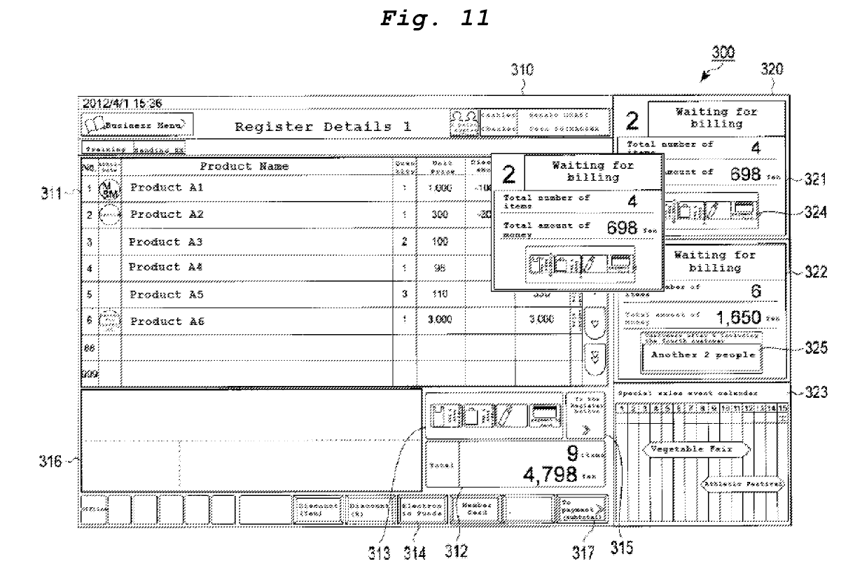

Next, the conceptual diagram shown in FIG. 7, the flowchart shown in FIG. 8, and examples of the billing screen 300 shown in FIG. 9 and FIG. 10 will be used to explain the operations when the cashier does a touch operation on the billing screen 300 at Step S204 (Yes of Step S205).

As shown in the flowchart of FIG. 8, first, the CPU 100 determines whether the given touch operation is the first defined operation for either of the thumbnails displayed in the subareas 321, 322 (Step S301). The first defined operation according to this embodiment is a single tap on either of the thumbnails displayed in subareas 321, 322.

When the first defined operation is detected (Yes of Step S301), the CPU 100 displays the billing data corresponding to the thumbnail, on which the given operation is performed, in the registration details area 310 (Step S302).

For example, when the first defined operation is performed for the thumbnail shown in subarea 321 from the state of the billing screen 300 shown in FIG. 5 (i.e., the CPU detects a single tap on the thumbnail in subarea 321), the CPU 100 displays all the product information contained in the billing data stored in area Q2 of the billing wait queue 103b, in the product information area 311 as shown in FIG. 9. At the same time, the CPU 100 displays the total number of items and the total amount of money contained in the given billing data, in the totals area 312.

Likewise, when the first defined operation is performed for the thumbnail displayed in subarea 322, it displays all the product information contained in the billing data stored in area Q3 of the billing wait queue 103b, in the product information area 311. At the same time, the CPU 100 displays the total number of items and the total amount of money contained in the given billing data, in the totals area 312.

After Step S302, the CPU 100 accepts touch operations for the billing screen 300 (Step S303), and waits until some touch operation happens (No of Step S304). If a touch operation happens on the billing screen 300 (Yes of Step S304), the CPU 100 determines if the given touch operation is the second defined operation (Step S305). The second defined operation according to this embodiment is a single tap on the thumbnail for the subtotal subarea 317, performed after the first defined operation.

When the second defined operation is detected (Yes of Step S305), the CPU 100 moves the billing data stored in the area Q1 which is at the head of the billing wait queue 103b to the Hold area 103c, and treats the given billing data as being on hold (Step S306). Furthermore, the CPU 100 moves the billing data corresponding to the thumbnail on which the second defined operation is performed to the area Q1 of the billing wait queue 103b (Step S307). Furthermore, in order to fill the area of the billing wait queue 103b made empty due to this, the CPU 100 advances and stores the billing data of the areas beyond the area in which the given billing data is stored, to an area one level ahead (Step S308).

FIG. 7 shows the movement aspects of the billing data D1 to D4 when the first and second defined operations are performed for the thumbnail of the billing data D2, in the billing screen 300 corresponding to the state of the billing wait queue 103b shown in FIG. 4. Upon receipt of the second defined operation (which necessarily follows receipt of the first defined operation), the billing data D1 moves to the Hold area 103c in Step S306, and the billing data D2 moves to the area Q1 in Step S307. The billing data D3 moves to area Q2, billing data D4 moves to area Q3 in Step S308. Because the billing data D2 has moved to area Q1, this billing data D2 will be fixed as the target of payment processing.

After the billing data is moved in this manner, the CPU 100 updates the display of the subareas 321, 322 to the thumbnails corresponding to the billing data stored newly in areas Q2, Q3, and at the same time, displays the thumbnail of the billing data stored in the Hold area 103c in the subarea 323 (Step S309). At this time, it also updates the display of the Number of people waiting area 325, based on the count of the billing data stored in the areas after area Q3.

FIG. 10 displays the billing screen 300 after the second defined operation is performed for the subarea 321 in the state shown in FIG. 9. The thumbnail of the billing data D3 stored newly in the area Q2 is now displayed in subarea 321, and the thumbnail of the billing data D4 stored newly in the area Q3 is now displayed in subarea 322. Also, since the count of the billing data stored in the areas after area Q3 reduces by 1 due to the movements in Steps S306 to S308, the number of people waiting being displayed in the Number of people waiting area 325 reduces from [Another 2 people] to [Another 1 person]. Furthermore, a thumbnail of the billing data D1 which is on hold is being displayed in subarea 323.

After Step S309, the operation of the CPU 100 moves to Step S203, and payment processing intended for the billing data being displayed in the registration details area 310 can be accepted.

Furthermore in Step S305, when the touch operation on the billing screen 300 is not the second defined operation (No of Step S305), the CPU 100 does not invoke the hold function, and displays the billing data that is stored in area Q1 once again in the registration details area 310 (Step S310). After that, the operation of the CPU moves to Step S203.

In Step S301, when the touch operation on the billing screen 300 is not the first defined operation (No of Step S301), the CPU 100 will determine as to whether the given operation is the third defined operation (Step S311). The third defined operation is an operation that specifies Hold in a procedure that differs from Steps S302 to S309.

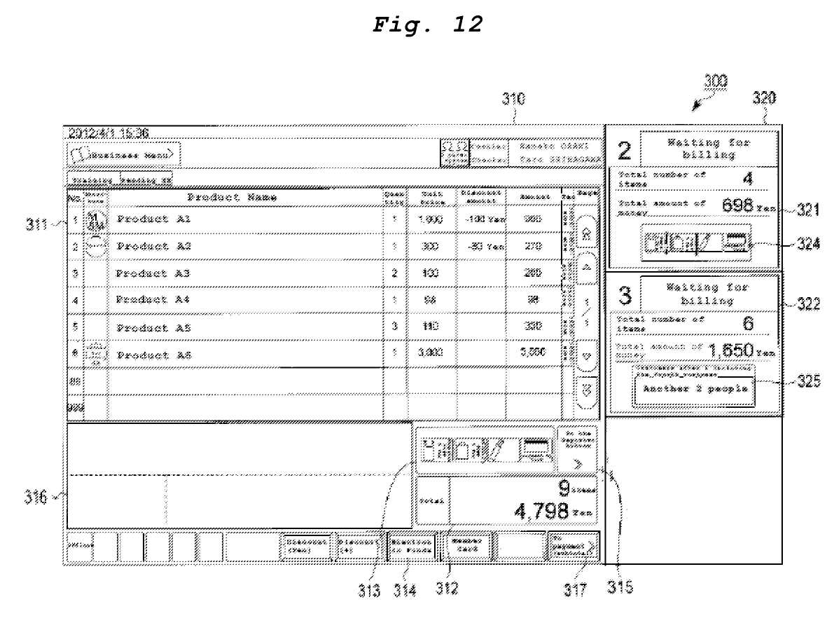

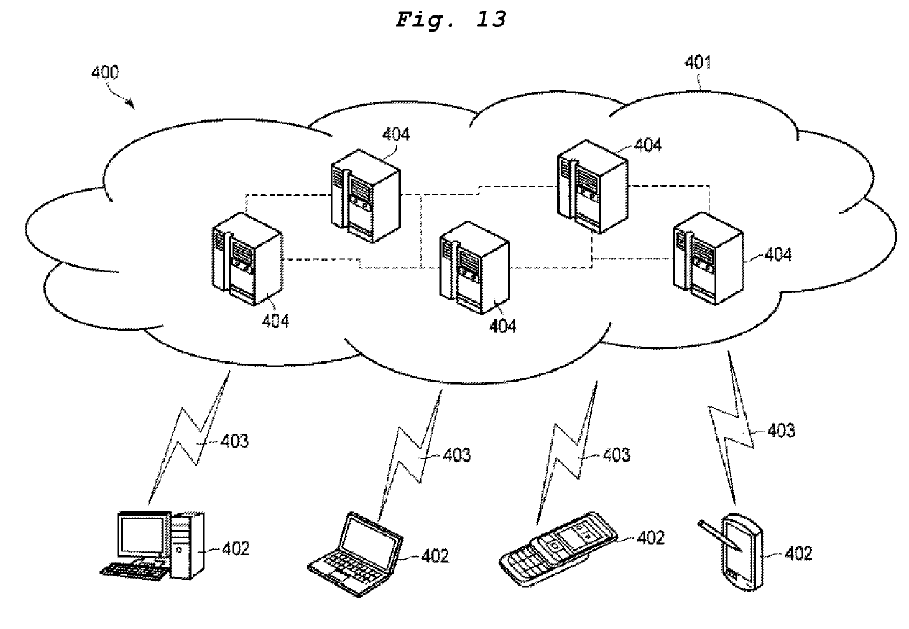

The third defined operation according to this embodiment is a touch operation that is different from the first and second defined operations. According to this embodiment, the third defined operation is a drag-and-drop operation, a double-tap operation, or a flick operation. For example, in the case where the third defined operation is a drag-and-drop operation, a user's finger is moved from the subarea 321 (or 322) to subarea 323. In the case where the third operation is a flick operation, the user's finger quickly swipes the subarea 321 (or 322). An example of the third defined operation as a flick operation is shown in FIG. 11. In the case where the third operation is a double-tap operation, the user's finger taps the subarea 321 (or 322) twice in quick succession.

When the third defined operation is detected (Yes of Step S311), the CPU 100 moves the billing data stored in the area Q1, which is at the head of the billing wait queue 103b, to the Hold area 103c, and treats the given billing data as being on hold (Step S312). Furthermore, the CPU 100 advances and stores the billing data of the areas including and after the area Q2 to an area one level ahead (Step S313) in order to fill the area Q1 of the billing wait queue 103b.

After such a movement, the CPU 100 displays the billing data stored in area Q1 in the Registration details area 310 (Step S314). Furthermore, the CPU 100 updates the display of the subareas 321, 322 to the thumbnails corresponding to the billing data newly stored in areas Q2, Q3, and at the same time, displays the thumbnail of the billing data stored in the Hold area 103c in the subarea 323 (Step S315). At this time, the CPU 100 also updates the display of the Number of people waiting area 325, based on the count of the billing data stored in the areas after area Q3. After the third defined operation is performed in the state as displayed in FIG. 5, the billing screen 300 will be as shown in FIG. 10.

After Step S315, the operation of the CPU 100 moves to Step S203, and payment processing intended for the billing data being displayed in the Registration details area 310 can be accepted.

In Step S311, when the touch operation on the billing screen 300 is not the third defined operation (No of Step S311), the CPU 100 determines as to whether the given operation is a resume operation that specifies the resumption of the payment processing for the billing data on hold (Step S316). The resume operation according to this embodiment is a tap on the thumbnail of the billing data on hold displayed in subarea 323.

When a Resume operation is detected (Yes of Step S316), the CPU 100 displays the billing data that is stored in the Hold area 103c, in the Registration details area 310 (Step S317). Furthermore, the CPU 100 displays messages such as On Hold Call up and the like in subarea 323 (Step S318). After Step S318, the operation of the CPU 100 moves to Step S203, and the payment processing intended for the billing data being displayed in the Registration details area 310 (i.e. the billing data stored in the Hold area 103c) can be accepted.

In Step S316, when the touch operation on the billing screen 300 is not the resume operation (No of Step S316), the CPU 100 executes other processing according to the given operation (Step S319). After Step S319, the operation of the CPU 100 moves to Step S203 and the payment processing intended for the billing data being displayed in the Registration details area 310 can be accepted.

The first, second, third defined operations and the resume operation are sufficiently defined according to various parameters (duration of touch, movement of touch, timing of successive touches, location of touch etc.) so that the CPU 100 can determine whether a particular touch operation is one of the first, second or third defined operations or the resume operation.

The description of the sequence of operations related to billing is concluded. In addition, the processing related to the hold that is to be realized by the CPU 100 constitutes the hold control means according to this embodiment.

In the POS system according to this embodiment, the thumbnail of the billing data waiting for payment processing is displayed in the Contents area 320. By verifying the total number of items and the total amount of money contained in this thumbnail, it is possible to easily understand the corresponding relationship between the customers waiting for billing and the billing data. Also, if the first defined operation is carried out for the thumbnail of the billing data, since the billing data corresponding to the given thumbnail is displayed in the registration details area 310, it is possible to easily verify the detailed contents of the billing data waiting for payment processing.

Furthermore, after the first defined operation is detected for either of the thumbnails in areas 321 or 322, and if the second defined operation is carried out for the given thumbnail, the billing data intended for payment processing will be put on hold, and the given thumbnail will become the target for payment processing. In the case of such a procedure, it will be possible to fix the given billing data by the second defined operation as the target of payment processing only after verifying the contents of the billing data which is the target of payment processing by the first defined operation. Thus, it will be possible to prevent mistakes of the cashier such as mixing up the billing data.

Also, even when the registration details area 310 is dragged or flicked to the Contents area 320 (third defined operation), the billing data intended for payment processing will be treated as being on hold. It is possible to invoke the hold function in this manner in a simple, visual, and easy to understand operation. Accordingly, the operability of the POS system is improved.

Even other than these instances, in the configuration disclosed in this embodiment, since various plans related to the hold function have been made, it is possible to offer a POS system in which the convenience of the Hold function can be improved remarkably.

The configuration disclosed in this embodiment can be realized by appropriately modifying each component in the implementation phase.

For example, in this embodiment as an example of a billing system, a POS system that includes of a POS terminal 1 and a scanner device 2 is illustrated. However, a billing system can also be a POS system that does not possess a scanner device 2 and can carry out a series of product registrations with the POS terminal 1. In this embodiment although a POS system provided in retail stores is illustrated, in the billing systems provided in stores that offer services such as restaurants and the like, the configuration related to the Hold function disclosed in the above mentioned embodiment may also be adopted.

In this embodiment, the first defined operation and second defined operation are taps on thumbnails. The third defined operation is a drag-and-drop, a flick, or a double-tap. The Resume operation is a tap. However, other operations can be appropriately adopted and/or defined. For example, the first defined operation, second defined operation and resume operation may also be other operations such as a long press or double tap and the like of the thumbnail. In addition, the third defined operation may also be another operation such as a long press, or a drag-and-drop in which the finger is moved to the registration details area 310 while touching the thumbnail displayed in the Contents area 320, or the like. When it is this type of third defined operation, for example the billing data being displayed in the registration details area 310 will be treated as being on hold, and at the same time, the billing data corresponding to the thumbnail of the contents area 320 which is touched may also be displayed in the registration details area 310.

Also, in this embodiment, the CPU 100 executed the computer programs stored in the ROM 102, RAM 103 or the Auxiliary storage device 105 to realize the processing indicated by FIG. 3, FIG. 6, FIG. 8 and the like. These computer programs may be installed in the POS system beforehand or may be downloaded in the POS system from the network. Alternately, similar programs that have been stored in recording media may also be installed in the POS system at an arbitrary time. For the recording media, its form does not matter as long as it is possible to store programs and it is possible for the device to be read such as a CD-ROM, memory card and the like. The functions that can be achieved by the installation or download of computer programs may also be items that realize that functionality by cooperating with the OS and the like of the POS system.

Functions that realize processing that is to be executed by the CPU 100 of the POS system, and some portions of the configuration that are to be provided in the POS system, may also be provided in a server device which is connected to communicate with the POS system.

When the system is architected in this manner, for example, Cloud computing can be used. More specifically, a Software Service form referred to as SaaS (software as a service) would be suitable.

FIG. 13 is a configuration diagram of a POS system that uses a Cloud system.

This POS system 400 possesses the Cloud 401, multiple terminal devices 402, multiple communication networks 403, and multiple server devices 404 connected to mutually communicate. Furthermore, the terminal device 402, Communication network 403 and server device 404 can also each be individuals.

The terminal device 402 can communicate with the Cloud 401 via the communication network 403. As a terminal device 402, a POS terminal 1 as described in this embodiment or, various computers such as a desktop or notebook type and the like, mobile phone device, mobile information terminal (PDA), a smart phone, a tablet and the like can be used appropriately.

For communication network 403, various networks such as the internet, a private network, Next Generation Network (NGN) or mobile network and the like can be used appropriately.

In a POS system 400 of this configuration, from among all the means for processing that is to be executed by the CPU 100 of the POS Terminal 1, at least one portion is provided by the server device 404, and the remaining processing is provided by the terminal device 402. Furthermore, some portions of all the processing may also be provided by sharing processing functions across multiple server devices 404.

For example, the display that corresponds to the cashier display 12 and the operation means that corresponds to the Touch panel 12a are provided in terminal device 402. Likewise, from among the storage means that corresponds to the billing wait queue 103b, the display control means that displays the billing screen 300 in the display provided in Terminal device 402, the payment control means that carries out the payment processing intended for the billing data displayed in the registration details area 310, and the hold control means to realize the hold function described using FIG. 8 and the like, at least one of them is provided in the server device 404. Further, from among these means, items that are not provided in the server device 404 are provided in the terminal device 402.

In a POS system 400 with this kind of configuration, it is sufficient to realize each process disclosed in this embodiment while making the terminal device 402 and server device 404 communicate appropriately. Even due to this POS system 400 it is possible to achieve the effects described in this embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A billing system, comprising:
a display section comprising at least one screen;
an operation section configured to detect a first defined operation and a second defined operation;
a storage section configured to store a plurality of billing data, each billing data related to one of one or more products or services to be sold in a corresponding transaction;
a display control section configured to display on the screen a first area that displays a first billing data of the plurality of billing data and a second area that displays a thumbnail of a second billing data of the plurality of billing data;
a payment control section configured to process a payment of money with respect to any billing data displayed in the first area; and
a hold control section configured to:
when the operation section detects the first defined operation on the thumbnail of the second billing data displayed in the second area, instruct the display control section to display on the screen the second billing data in the first area and treat the first billing data that was displayed in the first area before detecting the first defined operation as being on hold, and
when operation section detects the second defined operation on the thumbnail of the second billing data after the first defined operation, instruct the payment control section to begin processing a payment of money with respect to the second billing data that is displayed in the first area.

2. The billing system according to claim 1, wherein
the hold control section is further configured to, when the second defined operation is detected after the first defined operation, instruct the display control section to erase the thumbnail of the second billing data from the second area, and at the same time, display in the second area a thumbnail of the first billing data that is treated as being on hold.

3. The billing system according to claim 2, wherein
when the operation section detects a resume operation for billing data that is treated as being on hold, the hold control section is configured to instruct the display control section to display in the second area a thumbnail of the billing data that is displayed in the first area, and at the same time, display the billing data for which the resume operation is detected in the first area.

4. The billing system according to claim 3, wherein when the operation section detects the resume operation for billing data that is treated as being on hold, the hold control section instructs the payment control section to begin processing a payment of money with respect to the billing data for which the resume operation is detected.

5. The billing system according to claim 1, wherein the operation section is further configured to detect a third operation, and when the operation section detects the third operation on the first area, the hold control section treats the first billing data displayed in the first area as being on hold, and at the same time, instructs the display control section to display in the first area the billing data corresponding to any one of one or more thumbnails displayed in the second area.

6. The billing system according to claim 5, wherein, when the operation section detects the third operation on the first area, the hold control section instructs the display control section to erase the first billing data from the first area and display in the second area a thumbnail of the first billing data that is treated as being on hold.

7. A billing system comprising:
at least one terminal device including a display section having at least one screen and an operation section configured to detect a first defined operation and a second defined operation;
at least one server device;
a storage section configured to store a plurality of billing data, each billing data related to one of products or services to be sold in a corresponding transaction;
a display control section configured to display on the screen a first area that displays a first billing data of the plurality of billing data and a second area that displays a thumbnail of a second billing data of the plurality of billing data;
a payment control section configured to process a payment of money with respect to any billing data displayed in the first area; and
a hold control section configured to:
when the operation section detects the first defined operation on the thumbnail of the second billing data displayed in the second area, instruct the display control section to display on the screen the second billing data in the first area and treat the first billing data that was displayed in the first area before detecting the first defined operation as being on hold, and
when operation section detects the second defined operation on the thumbnail of the second billing data after the first defined operation, instruct the payment control section to begin processing a payment of money with respect to the second billing data that is displayed in the first area,
wherein at least one of the storage section, the display control section, the payment control section, and the hold control section are incorporated in the server device, and the remaining ones are included in the terminal device.

8. The billing system according to claim 7, wherein
the hold control section is further configured to, when the second defined operation is detected after the first defined operation, instruct the display control section to erase the thumbnail of the second billing data from the second area, and at the same time, display in the second area a thumbnail of the first billing data that is treated as being on hold.

9. The billing system according to claim 8, wherein
when the operation section detects a resume operation for billing data that is treated as being on hold, the hold control section is configured to instruct the display control section to display in the second area a thumbnail of the billing data that is displayed in the first area, and at the same time, display the billing data for which the resume operation is detected in the first area.

10. The billing system according to claim 9, wherein when the operation section detects the resume operation for billing data that is treated as being on hold, the hold control section instructs the payment control section to begin processing a payment of money with respect to the billing data for which the resume operation is detected.

11. The billing system according to claim 7, wherein the operation section is further configured to detect a third operation, and when the operation section detects the third operation on the first area, the hold control section treats the first billing data displayed in the first area as being on hold, and at the same time, instructs the display control section to display in the first area the billing data corresponding to any one of one or more thumbnails displayed in the second area.

12. The billing system according to claim 11, wherein, when the operation section detects the third operation on the first area, the hold control section instructs the display control section to erase the first billing data from the first area and display in the second area a thumbnail of the first billing data that is treated as being on hold.

13. The billing system according to claim 7, wherein instructions for any of the storage section, the display control section, the payment control section and the hold control section that are in included in the terminal device are provided from the server device over a network.

14. The billing system according to claim 7, wherein the at least one terminal device comprises one of a desktop computer, a notebook computer, a smart phone and a tablet.

15. A method comprising the steps of:
displaying in a first display area a first billing data of a plurality of billing data and in a second display area a thumbnail of a second billing data of the plurality of billing data;
detecting a first defined operation on the thumbnail of the second billing data and, in response thereto, treating the first billing data as being on hold and displaying the second billing data in the first display area; and
detecting a second defined operation on the thumbnail of the second billing data after the first defined operation and, in response thereto, processing a payment of money with respect to the second billing data.

16. The method according to claim 15, further comprising:
in response to detecting the second defined operation after the first defined operation, displaying a thumbnail of the first billing data that is treated as being on hold in the second display area.

17. The method according to claim 16, further comprising:
detecting a resume operation for the first billing data that is treated as being on hold and, in response thereto, displaying in the second display area a thumbnail of the billing data that is displayed in the first display area, and at the same time, displaying the first billing data in the first display area.

18. The method according to claim 17, further comprising:
in response to detecting the resume operation for the first billing data that is treated as being on hold, processing a payment of money with respect to the first billing data.

19. The method according to claim 15, further comprising:
detecting a third defined operation on the first display area and in response thereto, treating the first billing data displayed in the first display area as being on hold, and at the same time, displaying the billing data corresponding to any one of thumbnails displayed in the second display area in the first display area.

20. The method according to claim 19, further comprising:
in response to detecting the third defined operation on the first display area, displaying a thumbnail of the first billing data that is treated as being on hold in the second display area.
